(19) United States
(12) Patent Application Publication
(10) Pub. No.: US 2015/0033142 A1
(43) Pub. Date: Jan. 29, 2015

(54) METHOD FOR MANAGING IM SERVICES AND ELECTRONIC DEVICE USING THE SAME

(71) Applicant: Wistron Corporation, New Taipei City (TW)

(72) Inventors: Yung-Yen Chang, New Taipei City (TW); Hung-Lin Chen, New Taipei City (TW)

(73) Assignee: Wistron Corporation, New Taipei City (TW)

(21) Appl. No.: 14/093,044

(22) Filed: Nov. 29, 2013

(30) Foreign Application Priority Data
Jul. 25, 2013 (TW) 102126712

(51) Int. Cl. H04L 12/58

(52) U.S. Cl. CPC H04L 51/04
USPC 715/752

(57) ABSTRACT

A method for managing IM services and an electronic device using the same are provided. The method includes determining whether identification information respectively recorded in a first electronic device and a second electronic device is consistent when the first electronic device and the second electronic device are connected to each other through a network. The method also includes transmitting, by the second electronic device, at least one IM login information stored therein to the first electronic device if the identification information respectively recorded in the first electronic device and the second electronic device is consistent. The method further includes when a function button corresponding to a login function of the first electronic device receives a selection operation, executing, by the first electronic device, an IM service login procedure by using the at least one IM login information received from the second electronic device.

### CROSS-REFERENCE TO RELATED APPLICATION

This application claims the priority benefit of Taiwan application serial no. 102126712, filed on Jul. 25, 2013. The entirety of the above-mentioned patent application is hereby incorporated by reference herein and made a part of this specification.

### BACKGROUND

1. Field of the Invention

The present invention is directed to a method for managing instant messaging (IM) services. More particularly, the present invention is directed to a method for managing IM services which is combined with operation of function buttons and an electronic device method using the same.

2. Description of Related Art

With the progress of network technologies, people are more and more accustomed to communicating with others by using instant messaging (IM) services. In detail, with the use of the IM services for transmitting messages through a network, a user may communicate with others as long as the network is accessible. Meanwhile, most of the IM services do not charge additional expense for transmitting messages, which undoubtedly speed up the popularization of the IM services. In addition, the IM services not only support text messages, but also allow users to communicate by using audios, images or videos. Such contacting variety enhances communicative convenience and further attracts people to improve the will to use the IM services.

Under the situation that hundreds of IM service providers contend for this business, users commonly register and use a plurality of IM services. However, if a user has to manually input login information of the IM services in a plurality of electronic devices which he/she owns respectively so as to use the IM services by using each of the electronic devices. Apparently, the aforementioned login method is quite complicated and inconvenient. Additionally, due to the lack of a managing technique for managing various IM services logged in by the user, after the user logs in various IM services in one electronic device, it is difficult for him/her to handle the usage state of each of the IM services effectively.

### SUMMARY

Accordingly, the present invention provides a method for managing instant messaging (IM) services and an electronic device using the same, which are capable of simplifying a process of logging in a plurality of IM services for a user and improving the convenience for using the plurality of IM services with operations of function buttons.

The present invention provides a method for managing IM services, and the method includes the following steps. When a first electronic device and a second electronic device are connected to each other through a network, whether identification information respectively recorded in each of the first electronic device and the second electronic device is consistent is determined. If the identification information respectively recorded in each of the first electronic device and the second electronic device is consistent, at least one IM login information stored in the second electronic device is transmitted to the first electronic device by the second electronic device. When a function button corresponding to a login function of the first electronic device receives a selection operation, an IM service login procedure is executed by the first electronic device using the at least one IM login information received from the second electronic device.

In an embodiment of the present invention, each of the first electronic device and the second electronic device executes managing software, and the method for managing IM services further includes the following steps. A plurality of candidate IM services are obtained by the second electronic device through the managing software. A login managing interface is created and displayed on the second electronic device according to the candidate IM services. The IM login information is obtained via the login managing interface, wherein each of the IM login information corresponds to one of the candidate IM services storing the IM login information in the second electronic device.

In an embodiment of the present invention, the identification information of the first electronic device is generated by the managing software executed in the first electronic device according to a first user input obtained by the first electronic device, and the identification information of the second electronic device is generated by the managing software executed in the second electronic device according to a second user input obtained by the second electronic device.

In an embodiment of the present invention, the step of transmitting, by the second electronic device, the IM login information stored therein to the first electronic device includes the following steps. By the second electronic device, at least one information to be synchronized and to be transmitted is decided to the first electronic device from the IM login information stored in the second electronic device according to a login information obtaining state of the first electronic device, and the at least one information to be synchronized is transmitted to the first electronic device by the second electronic device.

In an embodiment of the present invention, the step of executing, by the first electronic device, the IM service login procedure by using the at least one IM login information received from the second electronic device when the function button corresponding to the login function of the first electronic device receives the selection operation further includes the following steps: automatically logging in the at least one IM service by using the at least one IM login information received from the second electronic device and providing a prompt effect indicating that all the IM services are logged in by using the function button corresponding to the login function.

In an embodiment of the present invention, the method for managing IM services further includes the following steps: deciding a currently controlled IM service from the at least one IM services that are logged in by the first electronic device, communicating with a contact through the currently controlled IM service whenever a function button corresponding to a chat function of the first electronic device receives a selection operation and providing a prompt effect corresponding to a communication state by using the function button corresponding to the chat function.

In an embodiment of the present invention, the method for managing IM services further includes the following steps: whenever a function button corresponding to a service switching function of the first electronic device receives a selection operation, alternately selecting a different currently controlled IM service from the at least one IM service that is logged in by the first electronic device and providing a prompt effect corresponding to the currently controlled IM service by using the function button corresponding to the service switching function.

In an embodiment of the present invention, the method for managing IM services further includes the following steps: when the at least one IM service that is logged in by the first electronic device receives a new message, providing a corresponding prompt effect by using a function button corresponding to a notification function of the first electronic device.

In an embodiment of the present invention, the method for managing IM services further includes the following steps: whenever a function button corresponding to a user state switching function of the first electronic device receives a selection operation, alternatively selecting a different current user state from a plurality of predetermined user states of a currently controlled IM service and providing a prompt effect corresponding to the current user state by using the function button corresponding to the user state switching function.

A method for managing IM services of the present invention is adapted to a first electronic device, and the first electronic device has logged in at least one IM service login and communicates with a second electronic device through a currently controlled IM service. The method includes the following steps: executing managing software to display a logout management interface and obtaining a logout mode via the logout management interface. The logout mode is a non-interactive logout mode, a first-class interactive logout mode or a second-class interactive logout mode. When a function button corresponding to a logout function of the first electronic device receives a selection operation, the first electronic device executes an IM service logout procedure according to the logout mode.

In an embodiment of the present invention, the step of executing the IM service logout procedure according to the logout mode when the function button corresponding to the logout function of the first electronic device receives the selection operation includes the following steps: directly instructing the first electronic device to log out of the at least one IM service if the logout mode is the non-interactive logout mode.

In an embodiment of the present invention, the step of executing the IM service logout procedure according to the logout mode when the function button corresponding to the logout function of the first electronic device receives the selection operation includes the following steps: transmitting a reply message to the second electronic device if the logout mode is the first-class interactive logout mode and then, instructing the first electronic device to log out of the at least one IM service. The reply message is a user-defined message received via the logout management interface or a system default message selected via the logout management interface.

In an embodiment of the present invention, the step of executing the IM service logout procedure according to the logout mode when the function button corresponding to the logout function of the first electronic device receives the selection operation includes the following steps: requesting the second electronic device to transmit a comment message if the logout mode is the second-class interactive logout mode, transmitting the comment message to a third electronic device when the comment message is received from the third electronic device and instructing the first electronic device to log out of the at least one IM service. The third electronic device is set via the logout management interface.

A method for managing IM services of the present invention is applied to a first electronic device which has logged in a currently controlled IM service. The method includes executing managing software to display a switching management interface, receiving device identification via the switching management interface, and when a function button corresponding to a device switching function of the first electronic device receives a selection operation, instructing the first electronic device to log out of the currently controlled IM service and controlling a second electronic device corresponding to the device identification to automatically log in the currently controlled IM service.

In an embodiment of the present invention, wherein the step of instructing the first electronic device to log out of the currently controlled IM service and controlling the second electronic device corresponding to the device identification to automatically log in the currently controlled IM service when the function button corresponding to the device switching function of the first electronic device receives the selection operation includes the following steps: determining whether identification information respectively recorded in each of the first electronic device and the second electronic device is consistent when the first electronic device and the second electronic device are connected to each through a network, if the determination result is yes, transmitting, by the first electronic device, IM login information of the currently controlled IM service to the second electronic device when the second electronic device lacks for the IM login information of the currently controlled IM service, such that the second electronic device automatically logs in the currently controlled IM service by using the IM login information received from the first electronic device.

The present invention provides an electronic device including a plurality of function buttons and a processor. The processor is operated together with the function buttons to perform the method for managing IM services.

In an embodiment of the present invention, each of the function buttons is an illuminable button and provides a prompt effect by using a light source with a specific color.

Based on the above, in the method for managing IM services and the electronic device using the same provided by the present invention, after the login information of a plurality of IM services is obtained by using an electronic device, the login information may be transmitted to other electronic devices which conform to the verification requirement to allow them to log in the IM services, such that the user does not have to input login accounts and passwords when using the IM services in different electronic devices. Meanwhile, not only the operations combined with the function buttons can facilitate in managing the login, logout and the switching operations of the IM services but also the prompt effects provided by the function buttons can allow the user to handle usage states of the IM services. Thereby, the user having a plurality IM service accounts may use the IM services by using a plurality of devices more conveniently.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the present invention.

FIG. 1 is a schematic diagram illustrating a method for managing IM services according to an embodiment of the present invention.

FIG. 2 is a flowchart illustrating the method for managing IM services according to an embodiment of the present invention.

FIG. 3 is a timing chart illustrating the packet delivery of the first and second electronic devices according to an embodiment of the present invention.

FIG. 4 is a flowchart illustrating a method for managing IM services according to another embodiment of the present invention.

FIG. 5 is a flowchart illustrating a method for managing IM services according to still another embodiment of the present invention.

FIG. 6A is a block diagram illustrating a first electronic device according to an embodiment of the present invention.

FIG. 6B is a schematic diagram illustrating the first electronic device according to an embodiment of the present invention.

FIG. 7 is a schematic diagram illustrating a method for managing IM services according to still another embodiment of the present invention.

### DESCRIPTION OF EMBODIMENTS

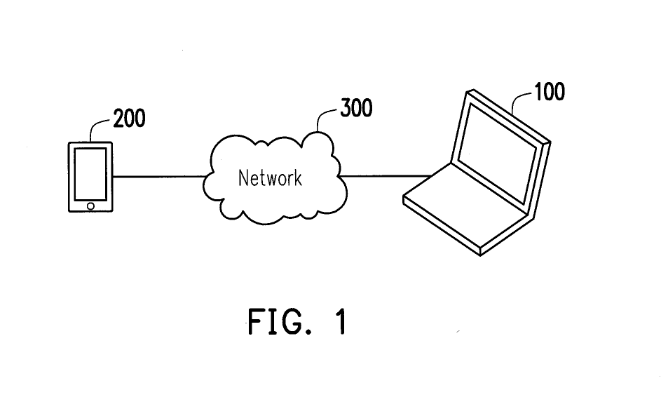

FIG. 1 is a schematic diagram illustrating a method for managing IM services according to an embodiment of the present invention. With reference to FIG. 1, in the present embodiment, a first electronic device 100, for example, a notebook computer (NB), and a second electronic device 200 is, for example, a smart phone, but the present invention is not limited thereto. The first electronic device 100 and the second electronic device 200 may be any device capable of computing and processing and being connected to a wired network and/or a wireless network. In the present embodiment, it is assumed that a user ever stored login information (e.g., a login account and a password) of one or more instant messaging (IM) services in the second electronic device 200. Then, when the first electronic device 100 and the second electronic device 200 are connected to each other via a network 300, and if identification information recorded in the first electronic device 100 and the second electronic device 200 are consistent, the second electronic device 200 may transmit part of or all of instant messaging (IM) login information stored therein to the first electronic device 100 via the network 300. Thereby, the first electronic device 100 may login to a corresponding IM service, without the user entering the login account and password again to the first electronic device 100.

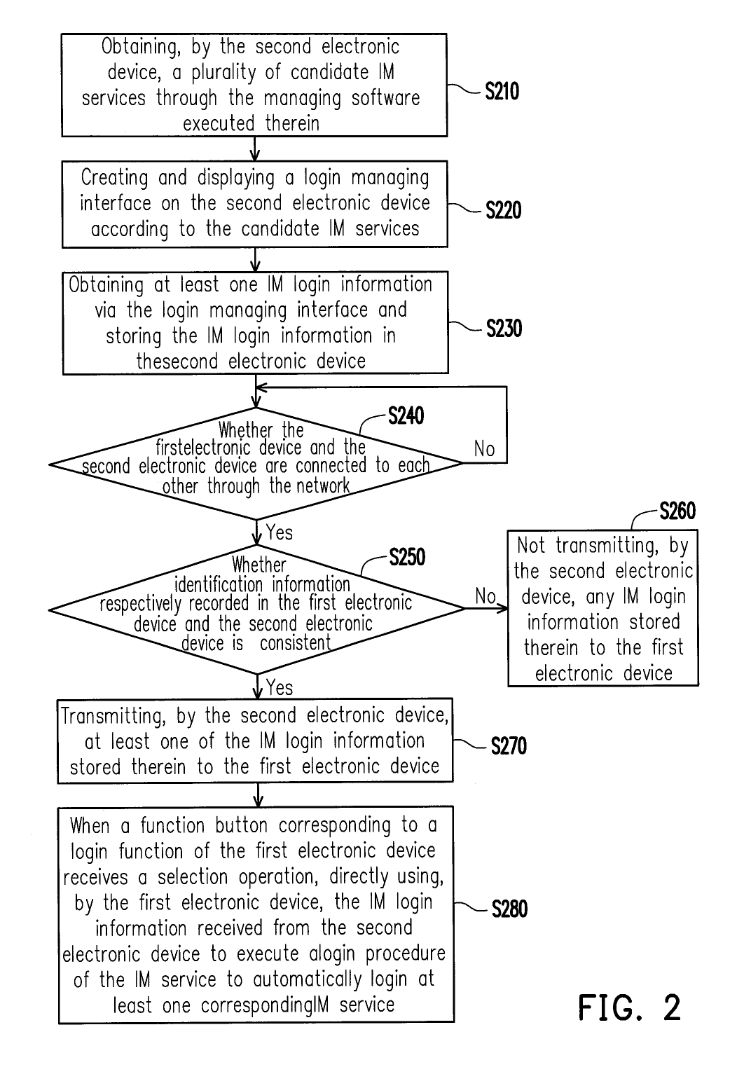

The method for managing the IM services will be described in detail with reference to FIG. 2 hereinafter. With reference to FIG. 1 and FIG. 2 simultaneously, in the present embodiment, the first electronic device 100 and the second electronic device 200 respectively executes managing software of the same type. When the managing software is started, a user input (e.g., an account and a password, a fingerprint or a voiceprint, which is not limited in the present invention) used to generate the identification information has to be obtained, such that the managing software may be normally operated later. In other words, the first electronic device 100 has identification information which is generated by the managing software executed in the first electronic device 100 according to a user input obtained by the first electronic device 100. Meanwhile, the second electronic device 200 also has identification information which is generated by the managing software executed in the second electronic device 200 according to a user input obtained by the second electronic device 200.

First, in step S210, the second electronic device 200 obtains a plurality of candidate IM services through the managing software executed therein. The candidate IM services are, for example, IM services corresponding to software installed in the second electronic device 200 by the user, or frequently used IM services.

Then, in step S220, the managing software executed in the second electronic device 200 creates a login managing interface according to the obtained candidate IM services and displays the login managing interface on a screen of the second electronic device 200. Meanwhile, in step S230, the managing software obtains at least one IM login information via the login managing interface and stores the obtained IM login information in the second electronic device 200. Each of the IM login information corresponds to a candidate IM service. For instance, the login managing interface may include an option corresponding to each candidate IM service and fields for inputting various types of IM login information. When clicking on one option corresponding to one of the corresponding candidate IM services, the user may enter login information of the candidate IM service in the corresponding fields. The managing software may collect a number of IM login information corresponding to different candidate IM services in a profile, and stores the profile in a storage unit of the second electronic device 200.

Afterward, in step S240, the second electronic device 200 repeatedly determines whether another electronic device is connected thereto through the network 300. For descriptive convenience, the electronic device connected with the second electronic device 200 through the network 300 is referred to as the first electronic device 100 hereinafter.

If the determination result of step S240 is yes, then in step S250, the second electronic device 200 determines whether identification information respectively recorded in each of the first electronic device 100 and the second electronic device 200 is consistent. That is, whether user inputs obtained by the managing software which is respectively installed in the first electronic device 100 and the second electronic device 200 when the managing software is started.

If the determination result of step S250 is no, then in step S260, the second electronic device 200 does not transmit any IM login information stored therein to the first electronic device 100, and up to this step, the method for managing the IM services of the present embodiment ended.

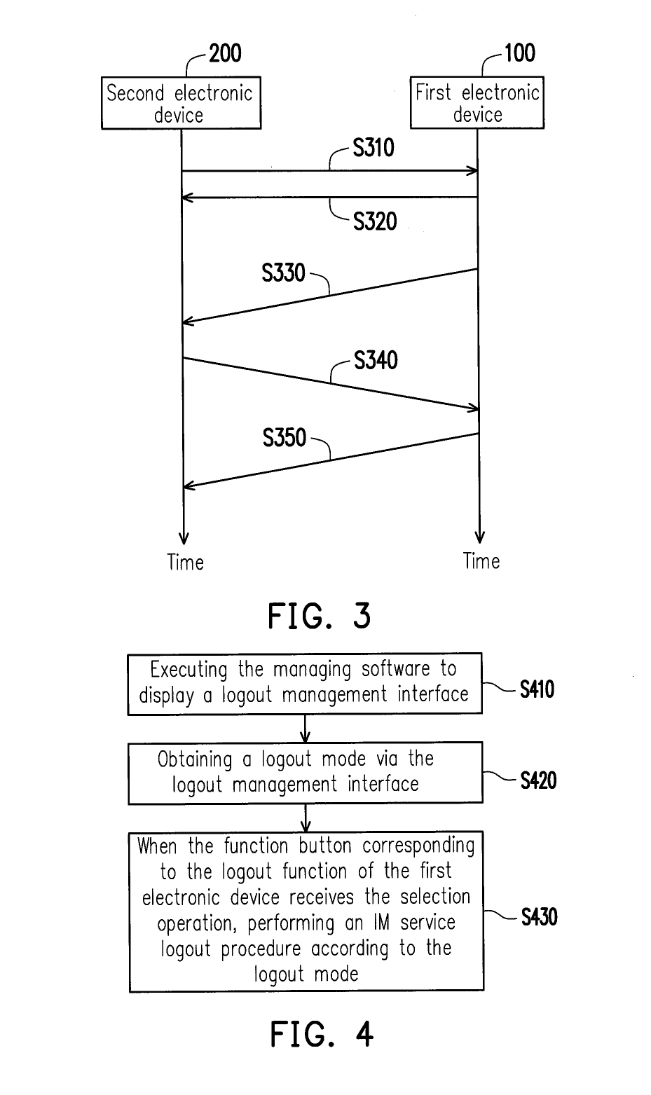

Otherwise, if the determination result of step S250 is yes, then in step S270, the second electronic device 200 transmits at least one of the IM login information stored therein to the first electronic device 100. In the present embodiment, the second electronic device 200, according to a login information obtaining state of the first electronic device 100, decides at least one information to be synchronized from all the IM login information stored in the second electronic device 200 and to be transmitted to the first electronic device 100 and transmits the information to be synchronized to the first electronic device 100 through the network 300. To be more specific, in the present embodiment, the first electronic device 100 and the second electronic device 200 confirm which login information is to be synchronized by a packet delivery manner, which will be further described with reference to FIG. 3 hereinafter.

With reference to FIG. 3, in step S310, the second electronic device 200 transmits a first-class packet to the first electronic device 100, and in step S320, the first electronic device 100 transmits the first-class packet to the second electronic device 200. The first-class packet contains device identification and a login information obtaining state of a device transmitting the first-class packet. The device identification is captured from, for example, a system management basic input output system (SMBIOS) by the managing software executed in the device which transmits the packet, while the login information obtaining state includes the IM services whose IM login information is stored in the device transmitting the packet. It is to be mentioned that in the embodiment illustrated in FIG. 3, the first-class packet is first transmitted from the second electronic device 200 and then transmitted to the first electronic device 100. However, in other embodiments, the first-class packet may also be first transmitted from the first electronic device 100 and then, transmitted to the second electronic device 200, or alternatively, the first-class packet may be transmitted from both the first electronic device 100 and the second electronic device 200 simultaneously.

After receiving the first-class packet from each other, the first electronic device 100 and the second electronic device 200 may accordingly know about the login information obtaining state of each other, so as to know whether the opposite party has the IM login information that it lacks for. In the present embodiment, in case the second electronic device 200 stores one or more IM login information that the first electronic device 100 lacks for, in step S330, the first electronic device 100 transmits a second-class packet to the second electronic device 200. The second-class packet records names and/or codes corresponding to the IM login information that the first electronic device 100 lacks for. After receiving the second-class packet from the first electronic device 100, the second electronic device 200 may decide at least one information to be synchronized from all the IM login information stored in the second electronic device 200, generate a third-class packet according to the information to be synchronized and as illustrated in step S340, transmit the third-class packet to the first electronic device 100. It is to be mentioned that the second electronic device 200 may perform an encryption processing on the third-class packet before transmitting it to the first electronic device 100. After receiving the third-class packet, in step S350, the first electronic device 100 returns a fourth-class packet configured for confirmation to the second electronic device 200. Therein, the second electronic device 200 may determine whether the first electronic device 100 successfully receives the information to be synchronized according to parameters contained in the fourth-class packet, or whether to re-transmit the information to be synchronized to the first electronic device 100.

After the aforementioned steps, the first electronic device 100 obtains at least one IM login information which is previously input to the second electronic device 200 by the user. Then, in step S280, when a function button corresponding to a login function of the first electronic device 100 receives a selection operation, the first electronic device 100 directly uses the IM login information received from the second electronic device 200 to execute a login procedure of the IM service to automatically login at least one corresponding IM service. By doing so, the user still may complete the login procedure of the IM service without manually inputting the IM login information in the first electronic device 100.

In the present embodiment, the function button corresponding to the login function may be an illuminable button, such as a light-emitting diode (LED) button, but the present invention is not limited thereto. When the user presses the function button corresponding to the login function, the button illuminates a light source with a specific color to prompt that all the IM services are logged in. In other embodiments, the function button corresponding to the login function may be a software button displayed in the screen and prompt that all the IM services are logged in by using a specific color.

It is to be mentioned that in addition to the function button corresponding to the login function, the first electronic device 100 further includes several function buttons corresponding to different functions, such that the user may manage the IM services by operations the aforementioned function buttons.

For instance, in a scenario where at least one IM service is logged in by the first electronic device 100, the first electronic device 100 alternately selects a different one from the IM services as a currently controlled IM service whenever a function button corresponding to a service switching function of the first electronic device 100 receives the selection operation and provides a prompt effect corresponding to the currently controlled IM service by using the function button corresponding to the service switching function. If a first, a second and a third IM services are logged in by the first electronic device 100, and the user is communicating with someone else by using the first IM service, the first IM service is a currently controlled IM service. Whenever the function button corresponding to the service switching function receives the selection operation, the first electronic device 100 alternately selects the second IM service, the third IM service and the first IM service as currently controlled IM services and provides the prompt effect corresponding to the currently controlled IM services by using light sources with specific colors. If the first, the second and the third IM services respectively correspond to a blue-color, a red-color and a yellow-color, the function button corresponding to the service switching function illuminates a blue light source when the first IM service is selected as the currently controlled IM service, the function button corresponding to the service switching function illuminates a red light source when the second IM service is selected as the currently controlled IM service, and the function button corresponding to the service switching function illuminates a yellow light source when the third IM service is selected as the currently controlled IM service.

As long as the first electronic device 100 decides a currently controlled IM service from all the logged in IM services and when a function button corresponding to a chat function of the first electronic device 100 receives the selection operation, the first electronic device 100 communicates with one contact through the currently controlled IM service and provides a prompt effect corresponding to a communication state by using the function button corresponding to the chat function. For instance, the function button is enabled to illuminate a light source with a specific color to indicate the communication is on-going.

In another embodiment, the first electronic device 100 further includes a function button corresponding to a user state switching function. Whenever the function button receives the selection operation, the first electronic device 100 alternately selects different current user states among different pre-determined user states in the currently controlled IM service and provides a prompt effect corresponding to the current user state by using the function button corresponding to the user state switching state. For instance, it is assumed that the predetermined user states of the currently controlled IM service includes an on-line, a busy and an off-line states and respectively correspond to the green color, the red color and the gray color. When receiving the selection operation that the first electronic device 100 selects the on-line state, the function button corresponding to the user state switching function illuminates a green-color light source for prompting. When receiving the selection operation that the first electronic device 100 selects the busy state, the function button corresponding to the user state switching function illuminates a red-color light source for prompting. When receiving the selection operation that the first electronic device 100 selects the off-line state, the function button corresponding to the user state switching function illuminates a gray-color light source for prompting.

On the other hand, when any one of the logged-in IM services of the first electronic device 100 receives a new message, the first electronic device 100 provides a corresponding prompt effect by using a function button corresponding to a notification function. For instance, whenever a new message is received, the function button corresponding to the notification function illuminates a light source with a specific color to inform the user.

In an embodiment below, the user of the first electronic device 100 may set a logout mode by utilizing the managing software executed in the first electronic device 100, such that when a function button corresponding to a logout function of the first electronic device 100 receives the selection operation, the first electronic device 100 executes a logout procedure of the IM service in execution according to the set logout mode. Detailed steps of the logout procedure of the IM service in executed by the first electronic device 100 according to the set logout mode will be described with reference to FIG. 4.

First, in step S410, the first electronic device 100 uses the managing software executed therein to display a logout management interface. For instance, after executing the managing software, a main operation interface is displayed, and the user may click on a specific option on the main operation interface to switch to the logout management interface.

Then, in step S420, a logout mode is obtained via the logout management interface. In the present embodiment, the logout mode is, for example, a non-interactive logout, a first-class interactive logout mode or a second-class interactive logout mode, and the logout management interface displays an option corresponding to each logout mode for the user. For instance, when the user selects an option corresponding to the non-interactive logout mode, the logout mode is set as the non-interactive logout mode, and so on, likewise.

Thereafter, in step S430, when the function button corresponding to the logout function of the first electronic device 100 receives the selection operation, the first electronic device 100 executes an IM service logout procedure according to the logout mode. Detailed operations of the three IM service logout modes will be described hereinafter.

In the non-interactive logout mode, when the function button corresponding to the logout of the function first electronic device 100 receives the selection operation, the first electronic device 100 is directly instructed to log out of all the IM services that are originally logged in thereby.

In the first-class interactive logout mode, when the function button corresponding to the logout function of the first electronic device 100 receives the selection operation, the first electronic device 100 automatically transmits a reply message to an electronic device communicating with the first electronic device 100 through the currently controlled IM service, and then the first electronic device 100 is instructed to log out of all the IM services that are originally logged in thereby. In the present embodiment, the return message automatically transmitted out by the first electronic device 100 is, for example, a user-defined message received via the logout management interface or a system default message selected via the logout management interface. That is to say, the user may previously set message content to be replied by himself/herself, or select one from a plurality of reply messages predetermined by the system, and therein, the content of the reply message set or selected by the user is recorded in the storage unit of the first electronic device 100.

In the second-class interactive logout mode, when the function button corresponding to the logout function of the first electronic device 100 receives the selection operation, the first electronic device 100 requests an electronic device communicating therewith through the currently controlled IM service to transmit a comment message (which may be pre-set by the user via the management interface), transmits the comment message to another electronic device through the network upon the receipt of the comment message and then, is instructed to log out of all the IM services that are originally logged in thereby. The comment message may be a text message, an audio message, a video message or the like, of which the type is not limited in the present invention.

In the aforementioned embodiment, when the user is about to log out the currently used IM service, beside directly logging out from the IM service, the first electronic device 100 may further transmit the pre-set reply message to another electronic device according to a user's setting to inform the electronic device about the reason of the logout. Alternatively, the first electronic device 100 may also require the opposite party to leave an important comment message and then transfer the same to another electronic device set by the user, such that the user may handle important events which the opposite party conveys.

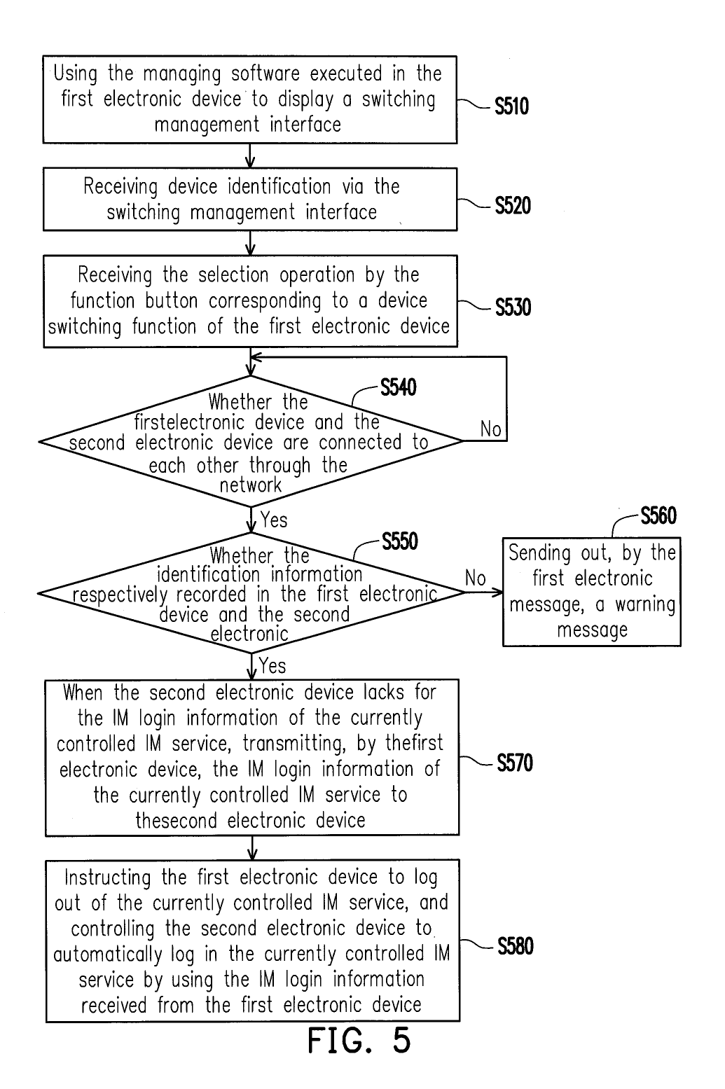

FIG. 5 is a flowchart illustrating a method for managing IM services according to still another embodiment of the present invention. In the present embodiment, if the user is communicating with another contact by using the currently controlled IM service through the first electronic device 100, the user may use a function button of the first electronic device 100 to log out the first electronic device 100 from the currently controlled IM service and allow another electronic device to automatically log in the currently controlled IM service.

First, in step S510, the first electronic device 100 uses the managing software executed therein to display a switching management interface. For instance, after being executed, the managing software displays a main operation interface, such that the user may click on a specific option on the main operation interface to switch to the switching management interface.

Then, in step S520, the first electronic device 100 receives device identification via the switching management interface. For instance, the switching management interface displays a menu listing various electronic devices, such as a smart phone, a notebook computer, a tablet computer or the like, for the user to select. When the user makes a selection via the switching management interface, the first electronic device 100 receives device identification corresponding to an electronic device.

Thereafter, in step S530, when the function button corresponding to a device switching function of the first electronic device 100 receives the selection operation, the first electronic device 100 logs out from the currently controlled IM service and controls the electronic device (referred to as a second electronic device hereinafter) to automatically log in the currently controlled IM service.

In detail, in step S540, the first electronic device 100 repeatedly determines whether the first electronic device 100 and the second electronic device are connected to each other through the network. When the first electronic device 100 is connected with the second electronic device through the network second electronic device, in step S550, the first electronic device 100 determines whether the identification information respectively recorded in the first electronic device 100 and the second electronic device are consistent, i.e., whether the user inputs obtained when the managing software respectively installed in each of the first electronic device 100 and the second electronic device is started are consistent.

If the determination result of step S550 is no, in step S560, the first electronic device sends a warning message to inform the user that the operation of the automatically switching the currently controlled IM service is incapable of being completed.

If the determination result of step S550 is yes, in step S570, and when the second electronic device lacks for the IM login information of the currently controlled IM service, the first electronic device 100 transmits the IM login information of the currently controlled IM service to the second electronic device. In detail, when the function button corresponding to the device switching function of the first electronic device 100 receives the selection operation, the first electronic device 100 sends out a fifth-class packet including the device identification and the code of the currently controlled IM service through the network, and then, any devices that are connected with the first electronic device 100 through the network may receive the fifth-class packet. However, among the devices, only an electronic device installed with the same managing software is capable of correctly analyzing the packet content and determining whether the packet requires to be further processed according to the device identification in the packet (i.e., whether the electronic device itself needs to switch to a target device for logging in the currently controlled IM service). If determining that itself is the target device after analyzing the received fifth-class packet, the second electronic device may determines whether itself has the IM login information for logging in the currently controlled IM service according to the code of the currently controlled IM service in the fifth-class packet. If not having the corresponding IM login information, the second electronic device may transmit the second-class packet as described in the aforementioned embodiment to ask the first electronic device 100 to transmit the IM login information of the currently controlled IM service to the second electronic device. And, in step S580, the first electronic device 100 logs out from the currently controlled IM service, and the second electronic device automatically logs in the currently controlled IM service by using the IM login information received from the first electronic device.

In the embodiment illustrated in FIG. 5, the user may select on which electronic device to use the IM service according to where he/she is located. For instance, if the user use a desktop computer at home and an IM service to communicate with friend, and when the user has to leave for some matter, he/she may press the function button corresponding to the device switching function on the desktop computer, such that the IM service automatically may be switched to log in another portable electronic device (e.g., a smart phone) to keep the communication from being stopped.

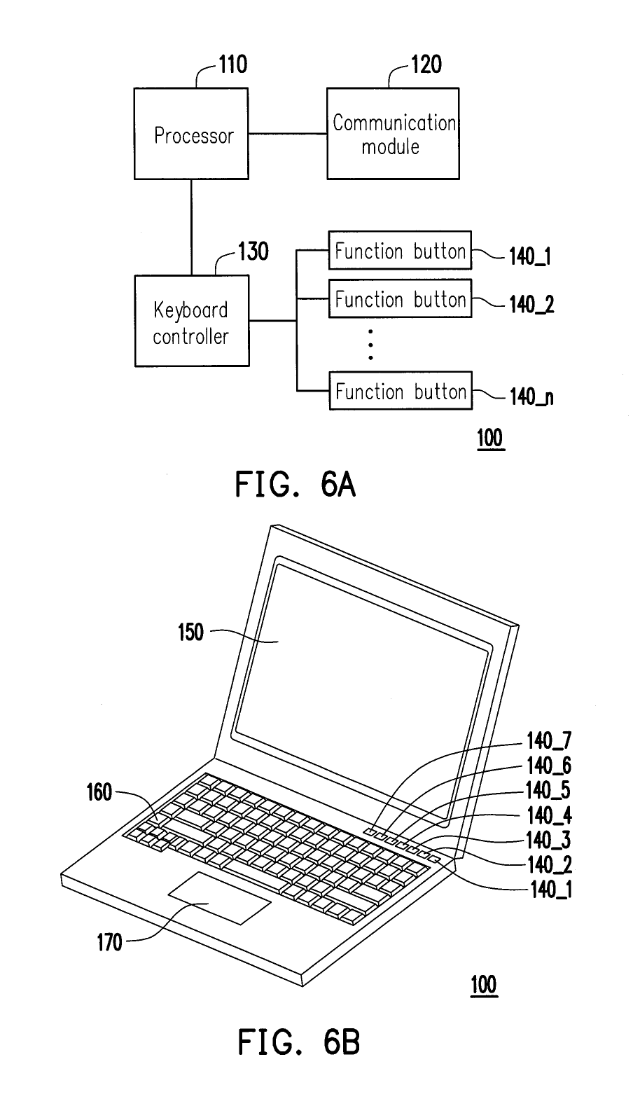

FIGS. 6A and 6B are respectively an internal block diagram and a schematic appearance diagram of the first electronic device 100 of the aforementioned embodiments.

With reference to FIG. 6A, the first electronic device 100 includes a processor 110, a communication module 120, a keyboard controller 130 and n function buttons 140_1 through 140_n, wherein n is a positive integer.

The processor 110 is, for example, a central processing unit (CPU) in charge of the operation of the first electronic device 100.

The communication module 120 may be a 3rd-generation (3G) mobile communication module, a wireless fidelity (WiFi) module, a wireless local area network (WLAN) module, a long term evolution (LTE) module or any other module having a function connecting a wired and/or wireless network. The communication module 120 is connected to a network and communicates with external devices according to instructions of the processor 110.

The keyboard controller 130 is configured to send out a corresponding interruption signal to the processor 110 when the function buttons 140_1 through 140_n are operated, such that the processor 110 performs corresponding follow-up processing. In detail, when the function buttons 140_1 through 140_n are operated, the keyboard controller 130 changes corresponding functional parameters in an embedded controller random access memory (ECRAM) and informs a basic input output system (BIOS) of the first electronic device 100, and then, the BIOS informs managing software executed by the processor 110 to perform follow-up processing according to an interruption signal (e.g. INT15) or a signal complying with the windows management instrumentation (WMI) standard established by Microsoft Inc.

In the present embodiment, the function buttons 140_1 through 140_n are, for example, light-emitting diode (LED) buttons, which are illuminable buttons have the same shape or different shapes and illuminate light sources with specific colors based on the control of the keyboard controller 130 to provide various prompting effects. As illustrated in FIG. 6B, if the first electronic device 100 is a notebook computer having a screen 150, a keyboard 160 and a touch panel 170, the function buttons 140_1 through 140_n may be disposed on the top right of the keyboard 160, but the present invention is not limited thereto.

In the embodiment illustrated in FIG. 6B, the first electronic device 100 has 7 function buttons 140_1 through 140_7, corresponding to a login function, a chat function, a service switching function, a notification function, a user state switching function, a logout function, and a device switching function, respectively. After managing software installed in the first electronic device 100 is executed, the keyboard controller 130 transmits a corresponding interruption signal to the processor 110 as long as any one of the function buttons 140_1 through 140_7 receives a selection operation of the user, such that the processor 110 performs the aforementioned method for managing the IM services.

It is to be mentioned that the second electronic device described in the embodiment above may have functions which are similar to those of the first electronic device. Nevertheless, even though in the embodiments above, two electronic devices are utilized for illustrating the method for managing IM services of the present invention, in a situation where the user has a plurality of electronic devices, as long as the managing software is installed and executed in all the electronic devices, IM login information of various IM services are transmitted from one of the electronic devices to the others by merely setting the IM login information in the one of the electronic devices. Thus, the function buttons of each of the electronic devices are utilized to execute the operations for managing the IM services, such as login, logout, switching and so on.

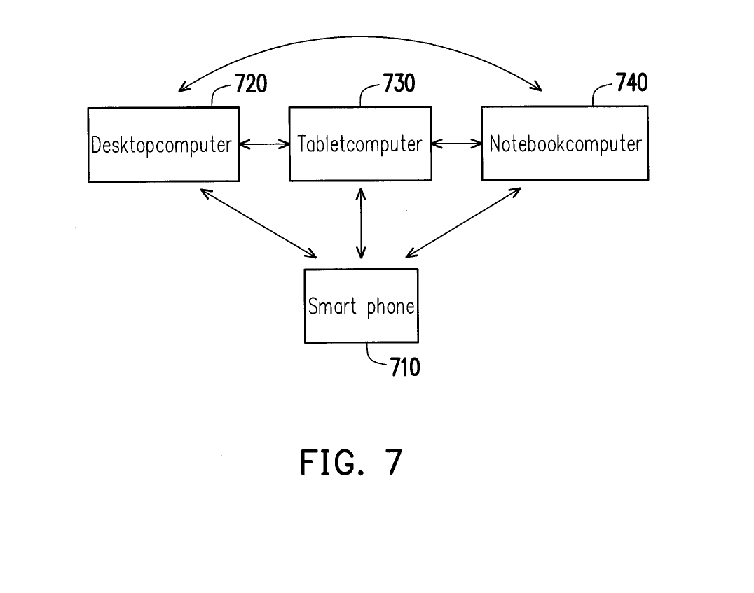

With reference to FIG. 7, it is assumed that a smart phone 710, a desktop computer 720, a tablet computer 730 and a notebook computer 740 execute the same managing software and have consistent identification information. Once the user sets IM login information of various IM services in the smart phone 710 and in the desktop computer 720, each two of the smart phone 710, the desktop computer 720, the tablet computer 730 and the notebook computer 740, after being connected to each other, may obtain the IM login information that has been set by the user through the packet delivery and after function buttons thereof receive the selection operation, execute the method for managing IM services corresponding to the function button. By doing so, the user does not have to manually input the IM login information of each IM service in each electronic device and may operate by using the function buttons more intuitively and conveniently when needing to use an IM service.

To sum up, in the method for managing IM services and the electronic device using the method of the present invention, through determining the identification information, the user can use corresponding IM services in a plurality of electronic device by merely inputting the IM login information one time. Meanwhile, through the operation combined with the function buttons for performing the login, the logout and the device switching operations of the IM service, the user can handle various IM services more quickly and accurately.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method for managing instant messaging (IM) services, comprising:
when a first electronic device and a second electronic device are connected to each other through a network, determining whether identification information respectively recorded in each of the first electronic device and the second electronic device is consistent;
if the identification information respectively recorded in each of the first electronic device and the second electronic device is consistent, transmitting, by the second electronic device, at least one IM login information stored therein to the first electronic device; and
when a function button corresponding to a login function of the first electronic device receives a selection operation, executing, by the first electronic device, an IM service login procedure by using the at least one IM login information received from the second electronic device.

2. The method according to claim 1, wherein each of the first electronic device and the second electronic device respectively execute managing software, the method further comprising:
obtaining, by the second electronic device, a plurality of candidate IM services through the managing software;
creating and displaying a login managing interface on the second electronic device according to the candidate IM services;
obtaining the at least one IM login information via the login managing interface, wherein each of the at least one IM login information corresponds to one of the candidate IM services; and
storing the at least one IM login information in the second electronic device.

3. The method according to claim 2, wherein the identification information of the first electronic device is generated by the managing software executed in the first electronic device according to a first user input obtained by the first electronic device, and the identification information of the second electronic device is generated by the managing software executed in the second electronic device according to a second user input obtained by the second electronic device.

4. The method according to claim 1, wherein the step of transmitting, by the second electronic device, the at least one IM login information stored therein to the first electronic device comprises:
deciding, by the second electronic device, at least one information to be synchronized and to be transmitted to the first electronic device from the at least one IM login information stored in the second electronic device according to a login information obtaining state; and
transmitting, by the second electronic device, the at least one information to be synchronized to the first electronic device.

5. The method according to claim 1, wherein the step of executing, by the first electronic device, the IM service login procedure by using the at least one IM login information received from the second electronic device when the function button corresponding to the login function of the first electronic device receives the selection operation further comprises:
automatically logging in the at least one IM service by using the at least one IM login information received from the second electronic device; and
providing a prompt effect indicating that all the IM services are logged in by using the function button corresponding to the login function.

6. The method according to claim 1, further comprising:
deciding a currently controlled IM service from the at least one IM service that is logged in by the first electronic device;
when a function button corresponding to a chat function of the first electronic device receives a selection operation, communicating with a contact through the currently controlled IM service; and
providing a prompt effect corresponding to a communication state by using the function button corresponding to the chat function.

7. The method according to claim 1, further comprising:
whenever a function button corresponding to a service switching function of the first electronic device receives a selection operation, alternately selecting a different currently controlled IM service from the at least one IM service that is logged in by the first electronic device and providing a prompt effect corresponding to the currently controlled IM service by using the function button corresponding to the service switching function.

8. The method according to claim 1, further comprising:
when the at least one IM service that is logged in by the first electronic device receives a new message, providing a corresponding prompt effect by using a function button corresponding to a notification function of the first electronic device.

9. The method according to claim 1, further comprising:
whenever a function button corresponding to a user state switching function of the first electronic device receives a selection operation, alternatively selecting a different current user state from a plurality of predetermined user states of a currently controlled IM service and providing a prompt effect corresponding to the current user state by using the function button corresponding to the user state switching function.

10. The method according to claim 1, wherein after the step of executing, by the first electronic device, the IM service login procedure by using the at least one IM login information received from the second electronic device when the function button corresponding to the login function of the first electronic device receives the selection operation, the method further comprises:
obtaining a currently controlled IM service through which the first electronic device communicates with a third electronic device from the at least one IM service;
executing managing software to display a logout management interface;
obtaining a logout mode via the logout management interface, wherein the logout mode comprises one of a non-interactive logout mode, a first-class interactive logout mode and a second-class interactive logout mode; and
when a function button corresponding to a logout function of the first electronic device receives a selection operation, executing an IM service logout procedure according to the logout mode.

11. The method according to claim 10, wherein the step of executing the IM service logout procedure according to the logout mode when the function button corresponding to the logout function of the first electronic device receives the selection operation comprises:
if the logout mode is the non-interactive logout mode, directly instructing the first electronic device to log out of the at least one IM service.

12. The method according to claim 10, wherein the step of executing the IM service logout procedure according to the logout mode when the function button corresponding to the logout function of the first electronic device receives a selection operation comprises:
if the logout mode is the first-class interactive logout mode, transmitting a reply message to the third electronic device, wherein the reply message is a user-defined message received via the logout management interface or a system default message selected via the logout management interface; and
instructing the first electronic device to log out of the at least one IM service.

13. The method according to claim 10, wherein the step of executing the IM service logout procedure according to the logout mode when the function button corresponding to the logout function of the first electronic device receives a selection operation comprises:
if the logout mode is the second-class interactive logout mode, requesting the third electronic device to transmit a comment message;
when the comment message is received from the third electronic device, transmitting the comment message to a fourth electronic device, wherein the fourth electronic device is set via the logout management interface; and
instructing the first electronic device to log out of the at least one IM service.

14. The method according to claim 1, wherein after the step of executing, by the first electronic device, the IM service login procedure by using the at least one IM login information received from the second electronic device when the function button corresponding to the login function of the first electronic device receives the selection operation, the method further comprises:
obtaining a currently controlled IM service used by the first electronic device from the at least one IM service;
executing managing software to display a switching management interface;
receiving device identification via the switching management interface; and
when a function button corresponding to a device switching function of the first electronic device receives a selection operation, instructing the first electronic device to log out of the currently controlled IM service and controlling a fifth electronic device corresponding to the device identification to automatically log in the currently controlled IM service.

15. The method according to claim 14, wherein the step of instructing the first electronic device to log out of the currently controlled IM service and controlling the fifth electronic device corresponding to the device identification to automatically log in the currently controlled IM service when the function button corresponding to the device switching function of the first electronic device receives the selection operation comprises:
when the first electronic device and the fifth electronic device are connected to each other through a network, determining whether identification information respectively recorded in each of the first electronic device and the fifth electronic device is consistent; and
if identification information respectively recorded in each of the first electronic device and the fifth electronic device is consistent, transmitting, by the first electronic device, IM login information of the currently controlled IM service to the fifth electronic device when the fifth electronic device lacks for the IM login information of the currently controlled IM service, such that the fifth electronic device automatically logs in the currently controlled IM service by using the IM login information received from the first electronic device.

16. An electronic device, comprising:
a plurality of function buttons; and
a processor, operated together with the function buttons to perform the method for managing IM services according to claim 1.

17. The electronic device according to claim 16, wherein each of the function buttons is an illuminable button and provides a prompt effect by using a light source with a specific color.
